(19) United States
(12) Patent Application Publication
(10) Pub. No.: US 2017/0142405 A1
(43) Pub. Date: May 18, 2017

(54) Apparatus, Systems and Methods for Ground Plane Extension

(71) Applicant: Praxik, LLC., Clive, IA (US)

(72) Inventors: Luke Shors, Minneapolis, MN (US); Aaron Bryden, Ninneapolis, MN (US)

(21) Appl. No.: 15/331,531

(22) Filed: Oct. 21, 2016

Related U.S. Application Data
(60) Provisional application No. 62/244,651, filed on Oct. 21, 2015.

(51) Int. Cl. H04N 13/02; G06T 19/00

(52) U.S. Cl. CPC H04N 13/0207; G06T 19/006; H04N 13/0275; H04N 2013/0081

(57) ABSTRACT

The disclosed apparatus, systems and methods relate to a vision system which improves the performance of depth cameras in communication with vision cameras and their ability to image and analyze surroundings.

### CROSS-REFERENCE TO RELATED APPLICATION(S)

This application claims priority to U.S. Provisional Application No. 62/244,651 filed Oct. 21, 2015 and entitled “Apparatus, Systems and Methods for Ground Plane Extension,” which is hereby incorporated by reference in its entirety under 35 U.S.C. §119(e).

### TECHNICAL FIELD

The disclosure relates to a system and method for improving the ability of depth cameras and vision cameras to resolve both proximal and distal objects rendered in the field of view of a camera or cameras, including on a still image.

### BACKGROUND

The disclosure relates to a vision system for improved depth cameras, and more specifically, to a vision system, which improves the ability of depth cameras to image and model, objects rendered in the field of view at greater distances, with greater sensitivity to discrepancies of planes, and with greater ability to image in sunny environments.

Currently, depth cameras utilizing active infrared (“IR”) technology, including structured light, Time of Flight (“ToF”), stereo cameras (such as RGB, infrared, and black and white) or other cameras used in conjunction with active IR have a maximum depth range (rendered space) of approximately 8 meters. Beyond 8 meters, the depth samples from these depth cameras become too sparse to support various applications, such as adding measurements or accurately placing or moving 3D objects in the rendered space. Additionally, the accuracy of depth samples is a function of distance from the depth camera. For instance, even at 3-4 meters, the accuracy of these prior art rendered spaces is inadequate for certain applications such as construction tasks requiring eighth-inch accuracy. Further, current applications are unable to properly image disparities on planes caused by certain irregularities or objects, such as furniture, divots, or corners. Further still, current depth cameras are unable to properly image locations that are hit by sunlight because of infrared interference created by the sun. Finally, because current depth cameras are unable to match the imaging range of color cameras, users are not able to use color images as an interface and must instead navigate less intuitive data representations such as point clouds.

Two consumer devices, Microsoft's Kinect® 2.0 (a ToF based camera) and Occipital's Structure Sensor® (a structured light-based camera), pair a depth camera with an HD vision camera. In the Kinect®, a depth camera and a vision camera are contained within the device. The Structure Sensor device is paired with an external vision camera, such as the rear-facing vision camera on an iPad®. A third device is Google' s Project Tango, which provides a platform which images space in three dimensions through movement of the device itself in conjunction with active IR. In these devices, depth information is typically rendered as a point cloud, which has an outer depth limit.

By pairing cameras, it is possible to project the depth data into the vision view, allowing for a more natural user experience in utilizing the depth data in a familiar vision photo format. However, these systems are not optimal when utilizing the depth data in a color photo or video or as part of a live augmented reality (“AR”) video stream. For instance, the color image may reveal objects and scenes that exceed the depth camera's range—a maximum of 8 meters in Kinect®—that cannot be accurately imaged by the current depth cameras. Further, even for closer objects in a color photo, the depth samples may not be accurate or dense enough to make accurate measurements. In these instances, utilizing depth data—such as by making measurements, placing objects, and the like—cannot be employed at all or have limited spatial resolution or accuracy, which may be inadequate for many applications.

It is possible to indicate areas of an image beyond where the depth point cloud exists in order to communicate to the user that depth data in these parts of the image are sparse or absent. However, this effectively discards much of the data in the color image and does not provide an intuitive user experience. Additionally, it is difficult and/or expensive to use a depth camera in large spaces at all, as it must be done by way of a laser scanner.

Therefore, there is a need in the art for depth cameras with improved rendering and accuracy in the image up to and beyond an 8 meter range, which accurately image discrepancies in planes, recognize corners, image in sunlight, accurately measure objects located on the imaged surface, and/or map these images onto vision cameras images or AR video streams in a user interface that is natively familiar.

### BRIEF SUMMARY

Discussed herein are various embodiments of a vision system utilized for imaging in depth cameras. The presently-disclosed vision system improves upon this prior art by retaining color information and extending a known plane to render the interpose depth information into a relatively static color image or as part of live AR. The disclosed vision system accordingly provides a platform for user interactivity and affords the opportunity to utilize depth information that is intrinsic to the color image or video to refine the depth projections, such as by extending the ground plane.

Described herein are various embodiments relating to systems and methods for improving the performance of depth cameras in conjunction with vision cameras. Although multiple embodiments, including various devices, systems, and methods of improving depth cameras are described herein as a “vision system,” this is in no way intended to be restrictive.

The vision system disclosed herein is capable of using discovered planes, such as the ground plane, to extrapolate the depth to further objects. In certain embodiments of the vision system, depth samples are mapped onto a vision camera's native coordinate system or placed on an arbitrary coordinate system and aligned to the depth camera. In further embodiments, the depth camera can make measurements of structures known to be perpendicular or parallel to the ground plane exceeding a distance of 8 meters. In certain embodiments, the vision system is configured to automatically remove objects such as furniture from an image and replace the removed object with a plane or planes of visually plausible vision and texture. In some embodiments, the system can accurately measure an extracted ground plane to create a floor plan for a room based on wall distances, as described below. Variously, the system can detect defects in walls, floors, ceilings, or other structures. Further, in some implementations the system can accurately image areas in bright sunlight.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a vision system including a depth camera configured to render a depth sample, b.a vision camera configured to render a visual sample, a display, and a processing system, where the processing system is configured to interlace the depth sample and the visual sample into an image for display, identify one or more planes within the image, create a depth map on the image, and extend at least one identified plane in the image for display. Other embodiments of this aspect include corresponding computer systems, apparatus, and computer programs recorded on one or more computer storage devices, each configured to perform the actions of the methods.

Implementations may include one or more of the following features. The vision system where the processing system is configured to utilize a frustum to extend the plane. The vision system further including a storage system. The vision system further including an application configured to display the image. The vision system where the application is configured to identify at least one intersection in the frustum. The vision system where the application is configured to selectively remove objects from the image. The vision system where the application is configured to apply content fill to replace the removed object. The vision system where the image is selected from a group including of a digital image, an augmented reality image and a virtual reality image. The vision system where the depth camera includes intrinsic depth camera properties and extrinsic intrinsic depth camera properties, and the vision camera includes intrinsic vision camera properties and extrinsic intrinsic vision camera properties. The vision system where the processing system is configured to utilize intrinsic and extrinsic camera properties to extend the plane. The vision system where the processing system is configured to project a found plane. The vision system where the processing system is configured to detect intersections in the display image. The vision system where intersections are detected by user input. The vision system where the intersections are detected automatically. The vision system where the processing system is configured to identify point pairs. The vision system where the processing system is configured to place new objects within the display image. The vision system where the processing system is configured to allow the movement of the new objects within the display image. The vision system where the processing system is configured to scale the new objects based on the extrapolated depth information. Implementations of the described techniques may include hardware, a method or process, or computer software on a computer-accessible medium.

One general aspect includes a vision system for rendering a static image containing depth information, including a depth camera configured to render a depth sample, a vision camera configured to render a visual sample, a display, a storage system, and a processing system, where the processing system is configured to interlace the depth and visual samples into a display image, identify one or more planes within the display image, and create a depth map on the display image containing depth information that has been extrapolated out beyond the range of the depth camera. Other embodiments of this aspect include corresponding computer systems, apparatus, and computer programs recorded on one or more computer storage devices, each configured to perform the actions of the methods.

Implementations may include one or more of the following features. The vision system where the processing system is configured to project a found plane. The vision system where the processing system is configured to detect intersections in the display image. The vision system where intersections are detected by user input. The vision system where the intersections are detected automatically. The vision system where the processing system is configured to identify point pairs. The vision system where the processing system is configured to place new objects within the display image. The vision system where the processing system is configured to allow the movement of the new objects within the display image. The vision system where the processing system is configured to scale the new objects based on the extrapolated depth information. Implementations of the described techniques may include hardware, a method or process, or computer software on a computer-accessible medium.

One general aspect includes a vision system for applying depth information to a display image, including a optical device configured to generate at least a depth sample and a visual sample, and a processing system, where the processing system is configured to interlace the depth and visual samples into the display image, identify one or more planes within the display image, and extrapolate depth information beyond the range of the depth camera for use in the display image. Other embodiments of this aspect include corresponding computer systems, apparatus, and computer programs recorded on one or more computer storage devices, each configured to perform the actions of the methods.

Implementations may include one or more of the following features. The vision system where the processing system is configured to place new objects within the display image. The vision system where the processing system is configured to allow the movement of the new objects within the display image. The vision system where the processing system is configured to scale the new objects based on the extrapolated depth information. Implementations of the described techniques may include hardware, a method or process, or computer software on a computer-accessible medium.

One or more computing devices may be adapted to provide desired functionality by accessing software instructions rendered in a computer-readable form. When software or applications are used, any suitable programming, scripting, or other type of language or combinations of languages may be used to implement the teachings contained herein. However, software need not be used exclusively, or at all. For example, some embodiments of the methods and systems set forth herein may also be implemented by hard-wired logic or other circuitry, including but not limited to application-specific circuits. Firmware may also be used. Combinations of computer-executed software, firmware and hard-wired logic or other circuitry may be suitable as well.

While multiple embodiments are disclosed, still other embodiments of the disclosure will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive in any way.

### BRIEF DESCRIPTION OF THE DRAWINGS

FIG. 1 depicts a schematic overview of an exemplary implementation of the vision system.

FIG. 2 depicts a schematic representation of the vision system according to an exemplary embodiment.

FIG. 3 is a flow chart showing the process of creating a three-dimensional depth-integrated color image.

FIG. 4A is a schematic view of an idealized frustum used by the disclosed vision system, also showing the prior art range.

FIG. 4B is a schematic view of an idealized frustum used by the disclosed vision system, generating a three-dimensional depth-integrated color image.

FIG. 4C depicts a perspective schematic flow diagram showing the removal of an object from an image and applying fill.

FIG. 4D depicts an embodiment in which the image is split into six regions using wall/floor dividing lines and relevant area dividing lines.

FIG. 5 is a view of an exemplary embodiment created by the vision system in an indoor environment.

FIG. 6 is a view of the embodiment of FIG. 5, demonstrating the measuring capabilities of an object to the identified ground plane.

FIG. 7 is a close up view of an image of the measured object in FIGS. 5-6 being measured by a standard tape measure to show the accuracy of the measurement by the vision system.

FIG. 8 is a view of the ground and floor planes found by the application both of which extend beyond the depth data. The ground plane is represented by a yellow matrix and a facing wall the user is interested in is represented as a turquoise matrix.

FIG. 9 is a view of an exemplary embodiment created by the vision system in an outdoor environment.

FIG. 10 is a schematic view of an alternative embodiment featuring a monopod.

FIG. 11 is a schematic overview of an implementation of the system utilizing shoe-ground intersections to establish camera height.

### DETAILED DESCRIPTION

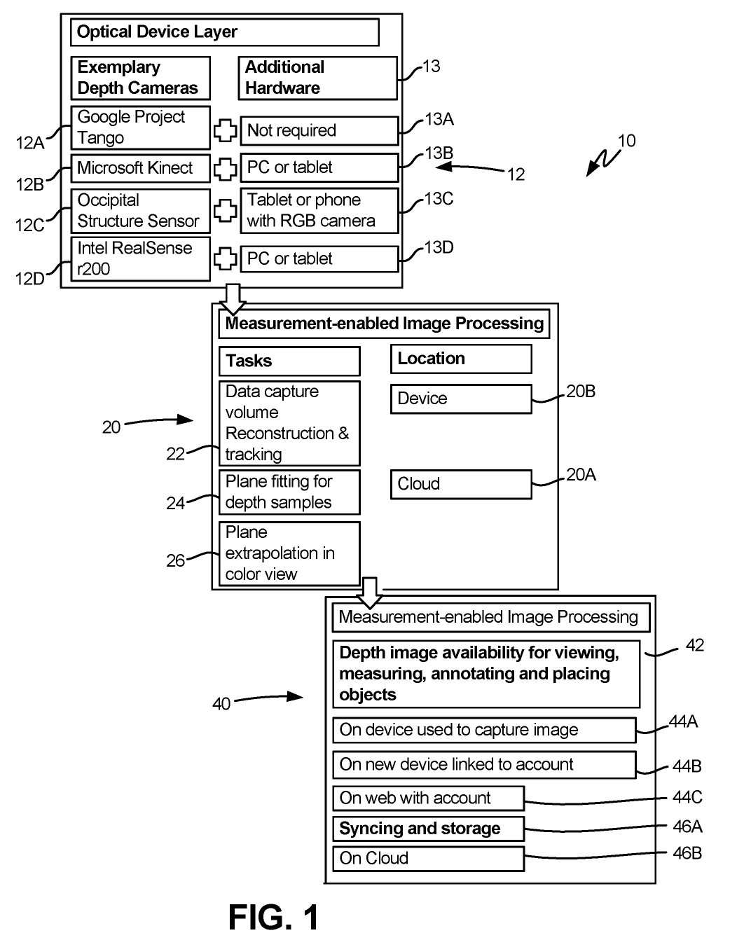

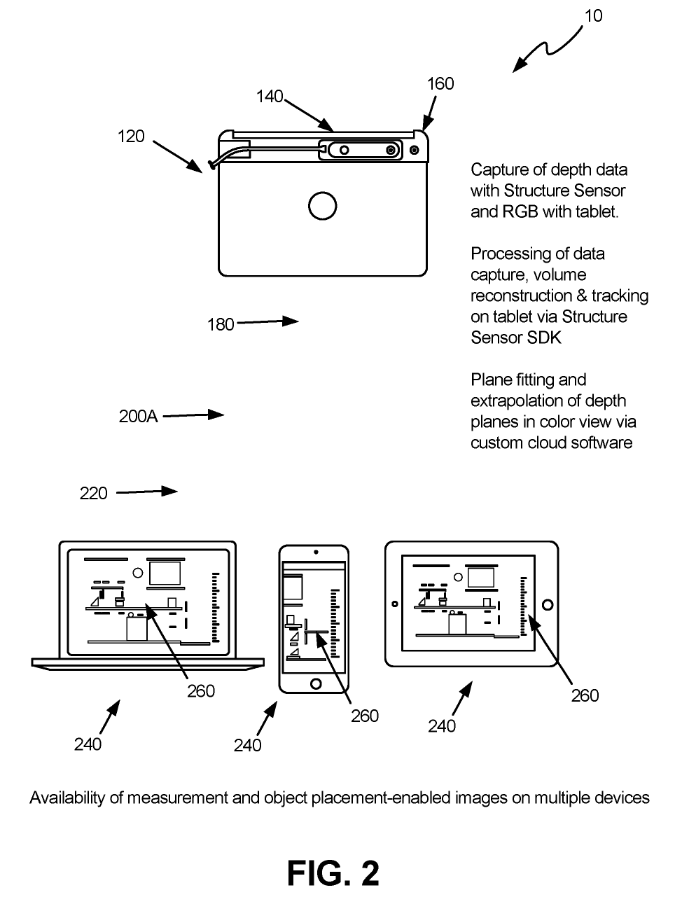

The disclosed devices, systems and methods relate to a vision system 10 capable of extending a plane in a field of view by making use of a combination of depth information and color, or “visual” images to accurately render depth into the plane. As is shown in FIGS. 1-2, the vision system 10 embodiments generally comprise a handheld (or mounted) optical device (box 12 in FIG. 1), a measurement-enabled image processing system, or “processing system” (box 20), and an application, interaction and storage platform, or “application” (box 40). In various embodiments, these aspects can be distributed across one or more physical locations, such as on a tablet, cellular phone, cloud server, desktop or laptop computer and the like. Optionally, the processing device, by executing the logic or algorithm, may be further configured to perform additional operations. While several embodiments are described in detail herein, further embodiments and configurations are possible.

FIGS. 1-10 depict various aspects of the vision system 10 according to several embodiments. In exemplary embodiments, the vision system 10 is able to incorporate depth information from an optical device (box 12) comprising at least one camera to render an interactive image containing highly accurate and detailed depth information. Through the image processing system (box 20), the vision system 10 establishes depth information about a known plane within that image and then extends that plane out into the image by way of known constants relating to the optical device (box 12) and visual information gained from, for example, a color image. Accordingly, in these embodiments, the vision system 10 operates to capture a depth image and a color image to interlace or otherwise align these images. By interlacing the images, depth information and visual information can be coupled with known camera constants to extend the planes within the field of view such that the final image contains detailed color and depth information which is rendered by application (box 40). Further, certain of these embodiments provide a graphical user interface (“GUI”), which is able to used to, for example, place and render an object within the final image as desired.

Turning to the drawings in greater detail, FIG. 1 depicts a flowchart of certain features of the system 10, including devices, processing, and applications, interactive platforms, and storage, according to an exemplary embodiments. For example, in these embodiments, the optical device (box 12) may comprise devices from Project Tango® (box 12A), Kinect® (box 12B), Structure Sensor® (box 12C), Intel RealSense r200® (box 12D), or the like. In each case, additional hardware (box 13), such as a PC or tablet, may be required, as is indicated in FIG. 1.

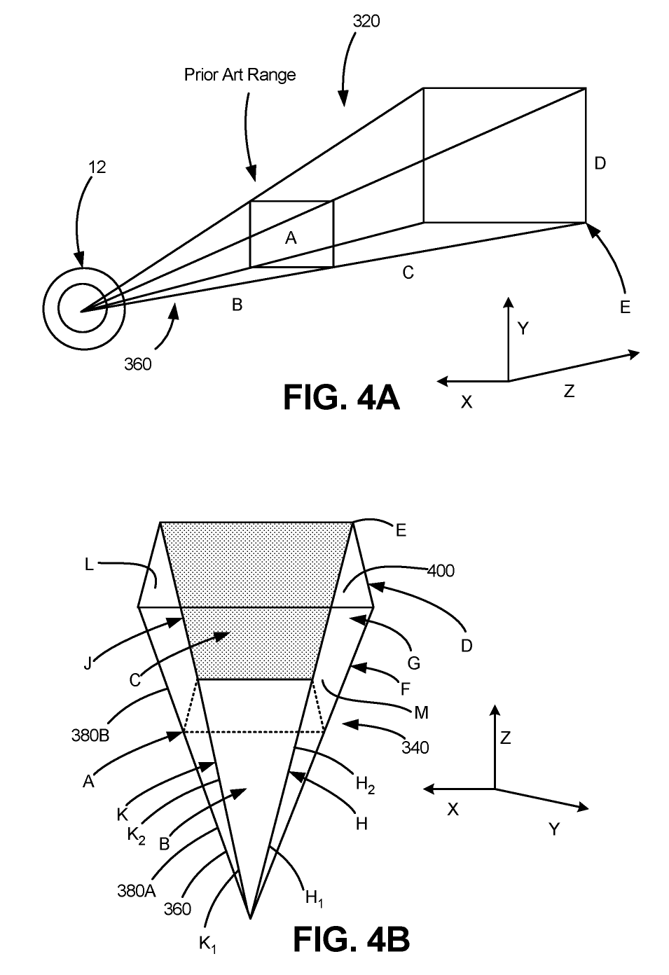

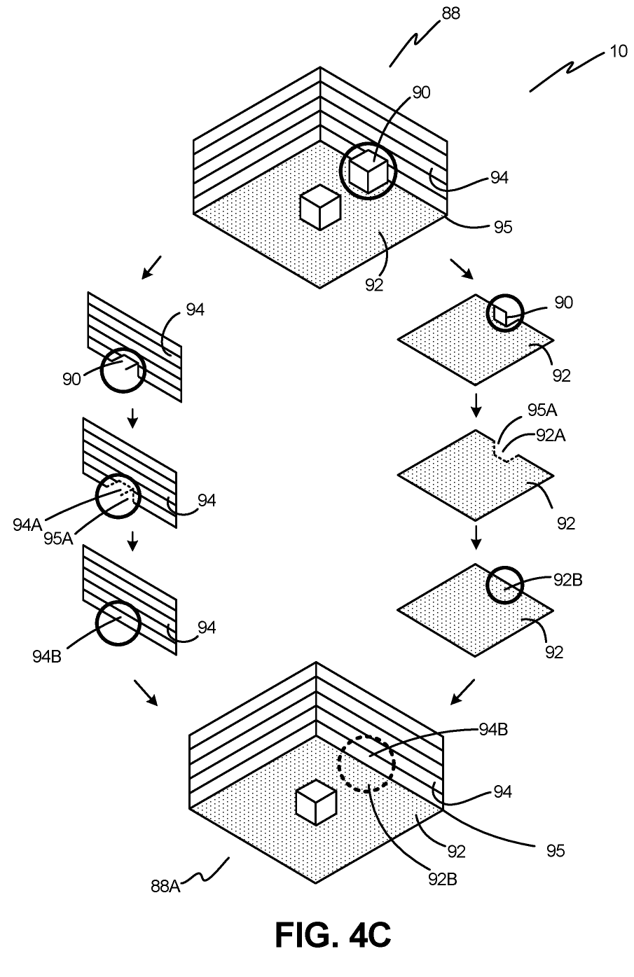

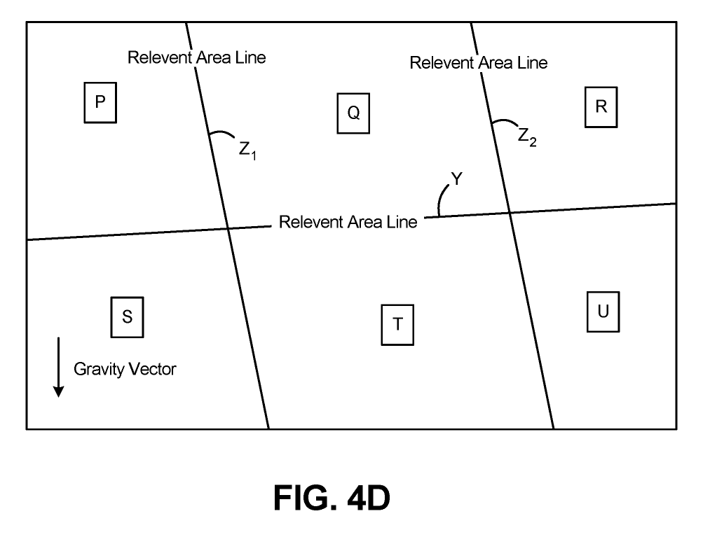

Continuing with FIG. 1, in various embodiments, the system 10 further comprises a processing system (box 20). The processing system (box 20) can perform data capture, volume reconstruction, and tracking (box 22). The processing system (box 20) can also perform plane fitting for depth samples (box 24), plane extrapolation in color view (box 26) and more, either in the cloud (box 20A), on the optical device (box 20B) or elsewhere, as is described in relation to FIGS. 4A-4B and FIGS. 5-9.

Continuing with FIG. 1, in certain embodiments, the application (box 40) can function to provide depth image availability (box 42) for viewing, measuring, annotating and placing objects, as well as synchronizing and storage (box 46A), such as by way of the cloud (box 46B). In certain embodiments, the depth image availability (box 42) can be performed on the optical device (box 44A), on a separate device by way of a linked account (box 44B), or on the internet (box 44C).

FIG. 2 depicts an exemplary embodiment of the vision system 10. In this embodiment, the vision system comprises an optical device 120 further comprising a range, or depth camera 140 and a vision camera 160. In the embodiment depicted, a structure sensor is provided as the depth camera 140 and a tablet camera is used as the vision camera 160 to capture color data and visual information. Other embodiments are possible. In exemplary embodiments, the depth camera 140 and vision camera 160 can be disposed substantially laterally on the optical device 120 relative to one another to be configured for binocular-like vision. As would be apparent to one of skill in the art, other configurations and layouts are possible in alternative implementations.

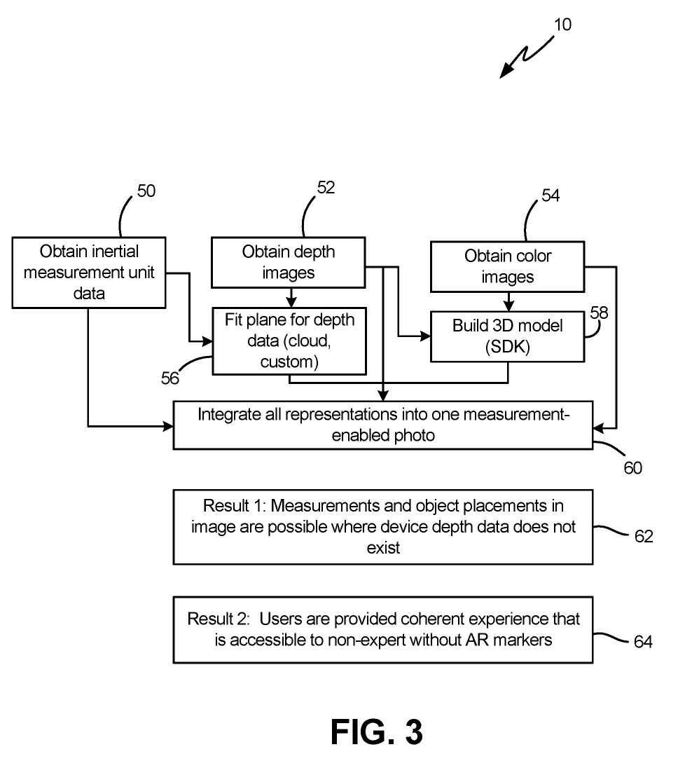

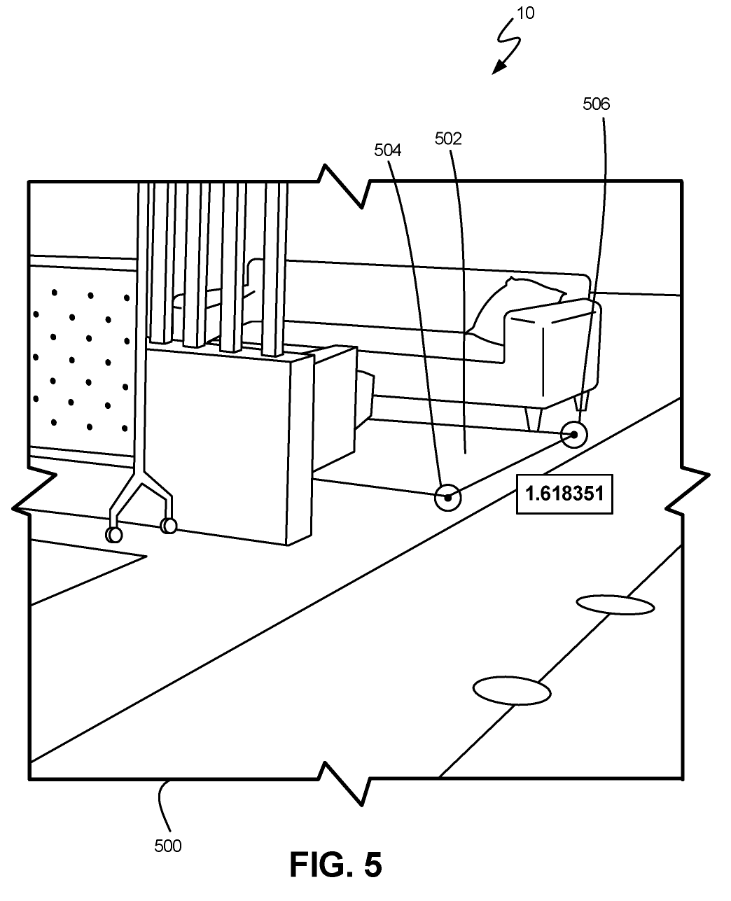

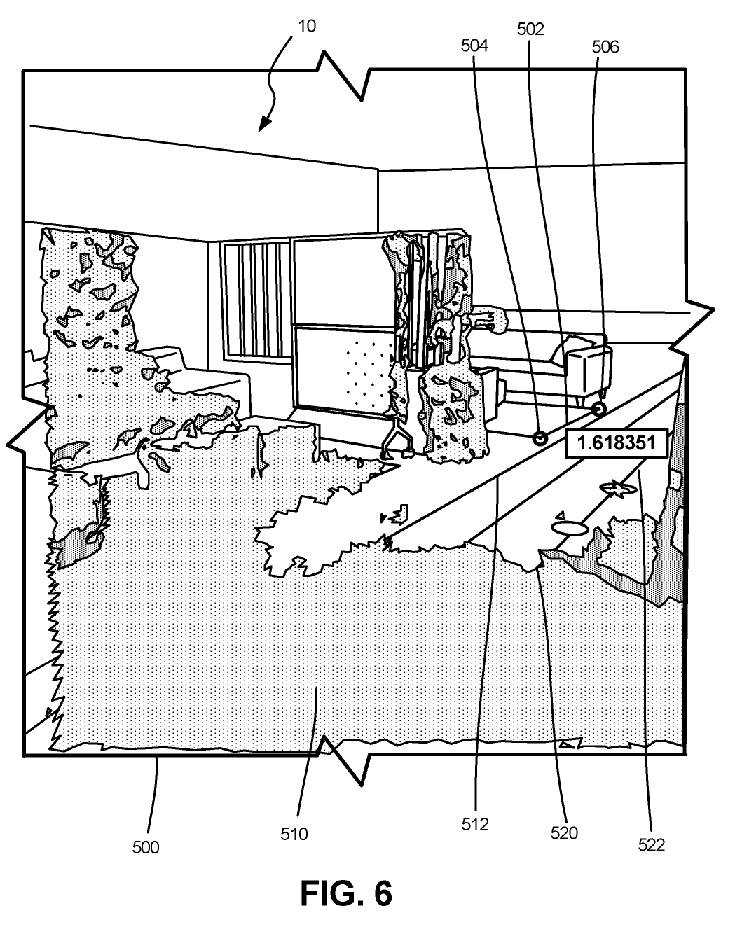

In these implementations, and as discussed further in FIGS. 3-4B, the vision system 10 makes use of the depth information from the depth camera 140 and the vision camera 160 to extend a known plane and provide accurate measurements as to the distance of objects, as is explained further in relation to FIGS. 5-9. In prior art systems with paired cameras, the range of the depth camera (box 14 in FIG. 1) is limited on the depth axis (Z-axis) at the plane defined at reference letter A in FIGS. 4A-B, or any of the planes adjacent to and ending at plane A. Current techniques teach the automatic reconstruction of the proximal ground plane designated as B in FIGS. 4A-B. However, even within this proximal space, depth samples may be patchy or sparse, as is shown in FIG. 6.

Returning to FIG. 2, in exemplary embodiments, the vision system 10 further comprises at least one communications connection 180, 220 that allow for electronic communication with various other processing or display components, such as a processing system (box 20 in FIG. 1) and/or alternative display and processing devices 240. In these embodiments, the system 10 generates an image 260 that incorporates both color photography and depth information for display to the user, either on the optical device 120 or on the processing devices (box 20). Further discussion of these images 260 is found herein in relation to FIG. 4 and FIGS. 6-10.

As discussed in relation to FIGS. 3-4C, after capturing both depth and color images and data, these images are aligned, or otherwise “fitted” to one another, such that the color image is effectively layered on the depth image for interlacing and further processing. Returning to FIG. 1, in various embodiments, the vision system 10 can perform data analysis and image processing in several distinct locations, for example in a cloud processing platform (box 20A). For example, in the depicted embodiment of FIG. 2, the processing of data capture, volume reconstruction and tracking can be performed on the optical device 120 by way of commercially available visual manipulation software, such as the open-source Structure Sensor® software development kit (“SDK”). Similarly, plane fitting and extrapolation of depth planes in the color view can done by way of custom cloud software application (as shown in box 40) in the processing system (box 20).

FIG. 3 depicts a flowchart showing a model implementation of the vision system 10. In this embodiment, the vision system 10 obtains data from several sources. The optical camera (box 12, FIG. 1) in inertial measurement unit data (box 50), depth images (box 52), and color images (box 54) can be obtained for processing. The inertial measurement unit data (box 50) and depth images (box 52) are fit to a found plane (designated at 56). The system utilizes the depth images (box 52) in conjunction with the color images (box 54) to build a three-dimensional model (box 58) that is integrated into a unified, three-dimensional depth-integrated color image (box 60). The three-dimensional depth-integrated color image (box 60) can comprise a static, depth-integrated color image that renders a three-dimensional space and contains depth information that has been extrapolated out beyond the range of the depth camera, as is discussed in FIGS. 4A-9. The depth-integrated color image may also comprise the ability to be measured, as is also discussed in relation to FIGS. 4A-9.

Returning to FIG. 3, there are several possible outcomes or utilities of the three-dimensional depth-integrated color image (box 60). A first possible result of this integration is that measurements and object placements in the resulting image are possible where device depth data does not exist and the ground plane is extended (box 62). A second result is that users can be provided with a coherent experience that is accessible to non-expert, and without augmented reality (“AR”) markers (box 64). Further discussion of these utilities appears in relation to FIGS. 5-9. As applied to the embodiment of FIG. 2, the three-dimensional depth-integrated color image (box 60) allows images in the field of view of the depth camera 140 to be placed over the objects rendered in the field of view of the vision camera 160 for subsequent display (as shown at 260 in FIG. 2).

FIG. 4A depicts a frustum 320 rendered outward from the point of view of the optical device 120. FIG. 4B depicts the three-dimensional depth-integrated color image 340 (also shown as box 60 in FIG. 3). FIG. 4A thus represents depth information 360, which is rendered as point cloud information generally limited at the plane A. FIG. 4B accordingly represents the integration of that depth information 360 into a static color image, wherein the visual information's native coordinate system 380A, 380B extends outward past plane A, for example to plane D.

In these embodiments, the three-dimensional depth-integrated color image 400 (also shown as box 60 in FIG. 3) is rendered by use of the frustum 320 to extend a plane, here B. In the embodiments of FIGS. 4A-B, the vision system 10 makes use of the proximal ground plane B as well as known camera parameters to extend depth information through the frustum 320. In exemplary embodiments, the system 10 is able to utilize intrinsic and extrinsic parameters for the optical device (box 12 in FIG. 1 and 120 in FIGS. 4A-4B), which may include a depth camera (shown at 140 in FIG. 2) and/or a vision camera (shown at 160 in FIG. 2). These known intrinsic and extrinsic camera parameters collectively describe the relationship between the 2D coordinates on an image plane and the 3D coordinates for any point in the scene in the space where the picture was taken (Zang, Z. Computer Vision: A Reference Guide. Spinger 2014. Pg. 81-85). For example, intrinsic parameters can relate to properties of the given camera (a depth camera 140 and/or vision camera 160, as shown in FIG. 2) such as distortion and focal length. Further, extrinsic camera characteristics can describe the transformation between the given depth or vision camera and the scene as well as the transformations between the depth and vision cameras, as would be understood by one of skill in the art.

Returning to the embodiments of FIGS. 4A-B, the proximal ground plane B is determined by mapping the space between the depth camera (shown at 140 in FIG. 2) and/or a vision camera (shown at 160 in FIG. 2) using known camera intrinsic properties (sometimes referred to as “intrinsics” in the art). Such intrinsic properties can including the camera settings, the field of view, any known distortion coefficients, and other properties of each camera. The vision system 10 can then map depth information 360 onto the native coordinate system (shown at 380 in FIG. 4B) of the vision camera (shown at 160 in FIG. 2). Alternatively, the system 10 can place the native coordinate system 380A, 380B in an arbitrary coordinate system and align it with the depth information 360. Accordingly, the coordinate system 380 and depth information 360 are integrated into a three-dimensional depth-integrated color image 400, as shown in FIG. 4B.

Continuing with FIGS. 4A-B, the vision system 10 can extrapolate from a reference plane, here the proximal ground plane B based on nearby depth samples to project onto a “found plane,” such as the distal ground plane (shown at C). In these embodiments, the system 10 incorporates the known geometries of the frustum 320 to compute the distal ground plane C, thereby extending the known ground plane B-C out into space, for example to the plane at D. In these embodiments, ground plane extension requires considering the 3D space beyond what the depth samples provide. Accordingly, the ground plane allows the vision system 10 user to precisely identify objects from greater distances, as well as to project and scale objects into a rendering of the field of view, as is described below in relation to FIGS. 5-9. The resulting three-dimensional depth-integrated color image (box 60 in FIG. 3) is rendered by establishing a reference plane B with a junction, such as the proximal ground plane B, using established approaches such as Random Sample Consensus (“RANSAC”). It is therefore possible to place information in areas of the image, which do not have depth data.

Continuing with FIGS. 4A-B, in another exemplary embodiment, the vision system 10 can measure areas on the image that are on the distal ground plane C, and therefore beyond the scope of a depth camera. In at least one embodiment, it can also make measurements on structures known to be perpendicular or parallel to the ground plane such as walls F or ceilings G at distances exceeding the proximal ground plane B.

In the embodiments of FIGS. 4A-B, three-dimensional depth-integrated color image 400 of the optical device (also represented by the visual information's native coordinate system 380A, 380B) can be used to identify the location of points of interest to extend the plane automatically or manually. Various embodiments of the vision system 10 are thereby able to detect walls automatically, by indentifying and mapping one or more junctures or intersections H in the planes in the proximal ground plane B. In further embodiments, user input can be utilized to define the location of points of interest. For example, when the implementation is configured to utilize a mouse or tablet, users are able to identify one or more points of interest J, K by selecting the points inside visual image, corresponding to the visual information's native coordinate system 380A, 380B within the three-dimensional depth-integrated color image 400. The user is thereby able to define these junctures or intersections between the ground plane and a wall J or a wall J and a ceiling F. In certain embodiments, the vision system 10 is able collect further information about the native coordinate system 380A, 380B by acquiring additional images. For example, additional images relating to the angles between the “wall” M and “floor” C or between the “walls” M, L can be used. These additional images can also be captured by directing the user to move towards the desired wall and monitoring the video feed or simply asking the user to take a snapshot of a particular juncture.

By way of example, these embodiments can thereby utilize the ground plane B-C from the depth sensor and/or knowledge of the distance between the camera and a fixed point on the ground (as discussed in relation to FIG. 3) to achieve better imaging results. These results contain more depth by projecting the frustum 320 outward into the distal ground plane B or other surface, so as to achieve an accurate rendering of the distances to various points on the displayed image (as discussed above in relation to the image 260 in FIG. 2).

Continuing with FIGS. 4A-B, in at least one embodiment, these points of interest (for example K) are detected by the optical device (box 12 in FIG. 1), including the depth camera 140 and a vision camera 160 of FIG. 2). Each point in the point cloud has a different level of potential error associated with it in both the depth direction and the orthogonal vectors to the depth direction. These embodiments can use this separable error information to determine how far away from a point a ground plane can be. In these embodiments, the vision system uses the combination of this data from all the points to refine the fit of the ground plane such that points where the vision system detects one or more aspects of error is more or less than other points.

In some embodiments the RANSAC algorithm is modified. In these implementations, the refinement step is modified such that only the samples with an error below a desired error threshold (determined either automatically by the histogram of sample errors or set in advance) are used to refine the fit plane and the inlier determination step uses the error properties of each sample to determine whether it is an inlier for a given plane. In other embodiments the complex error properties of each sample are used to find the plane that best explains all inliers within their error tolerances. In these cases samples with more error could be weighted differently in a linear optimization or a non-linear global optimization could be used.

In exemplary implementations, a user is able to provide visual input to identify intersections and improve functionality. By using known graphical display approaches, the plausible planes can be presented to, or accessed by, a user. This can be done, for example, on a tablet device by “tapping” or “clicking” on a part of the image contained in these planes. In certain circumstances, the identification of intersections can be refined by tapping in areas that either are or are not part of the relevant plane, as prompted.

In certain embodiments, an established ground plane B-C can be combined with either manual selection or automatic detection of the intersections between the ground plane and the various walls M, L or other planes that are disposed adjacent to the ground plane B-C. These embodiments are particularly relevant in situations where it is desirable to create a floor plan, visualize virtual objects such as paintings or flat screen televisions on walls, or in the visualization of an image that already has objects that should be visually removed. For example, a user may wish to buy a new table in a dining room that already has a table and chairs. In these situations, the presently disclosed system can allow a user to remove their existing from the room and then visualize accurate renderings of new furniture in the room, such as on a website.

As will be appreciated by the skilled artisan, in implementations utilizing automatic detection, the vision system 10 can be configured to employ semantic labeling capabilities from convolutional neural nets to perform line detection filtered by parts of the image that are likely to be on the ground plane. For example, in these implementations the system 10 can predict a maximum distance from the camera (the depth camera 140 and/or vision camera 160 of FIG. 2) for a wall M and project a virtual ground plane C into the image that extends adjacent to the wall M. In various alternate embodiments, other techniques can be used to find plausible intersections between the ground and perpendicular planes.

In some examples, the system 10 is able to split aspects of an image that are not identified by semantic labeling by performing a number of steps. For example, as described herein, in these implementations, foreground objects appearing within the image can be split by an intersection line between the floor and the ground. In these implementations, the system 10 can automatically find the ground plane-wall intersection that contains the maximal separation of color, texture or other global and local properties of the separated regions. This can be achieved using an iterative algorithm wherein the system generates a large number of candidate wall/floor separation lines and then refine the candidate wall/floor separation by testing perturbations to these candidates.

A model wall-floor separation refinement algorithm is given herein. As described herein in greater detail, each iteration consists of several steps that may be performed in any order.

In one step, the system 10 establishes an image and ground plane, as discussed above.

In another step, the system identifies initial approximate wall/floor intersection point pairs. In various implementations, these can be generated from the user, from candidate wall/floor intersection point pairs from feature/line finding and/or randomly generated candidate wall/floor intersection point pairs for use.

For each given wall/floor intersection point pair, several additional steps can be performed by the system. In these implementations, a wall/floor intersection point pair is a set of 2 points in an image that define a line separating a wall (or other plane) from the floor. Examples are shown at K₁, K₂ and H₁, H₂ in FIG. 4B. in various implementations, the defined reference line K, H can either extend beyond the selected points K₁, K₂ and H₁, H₂ or the selected points can represent corners of a wall intersecting with another wall, as would be understood. in these implementations, it would be understood by one of skill in the art that the ground plane consists of the area “in front” of the dividing line and the wall consists of the area “behind” the dividing line.

In another step, the system performs an evaluation function. In these implementations, for a given wall/floor intersection point pair, the system is able to determine the difference between the global and local properties of the floor areas as indicated by the intersection pair differ. This step is important in certain situation. As one example, in a living room setting where the ground plane is a patterned blue carpet and the wall is brown wallpaper, local lighting differences would may impair the ability to determine intersection points with segmentation. However, splitting the non-foreground parts of image into 2 areas—wall/plane and ground plane—with a straight line allows the system to evaluate predictions about how these difficult areas are split by comparing how different the regions are given a variety of metrics, such as color, texture, and other factors. in various implementations, the difference is assigned a numeric score for evaluation and thresholding.

One examplary refinement algorithm is provided herein, and would be appreciated by one of skill in the art. While several optional steps are provided, the skilled artisan would understand that various steps may be omitted or altered in various alternate embodiments, and this exemplary description serves to illuminate the process described herein.

In this exemplary implementation, for n iterations, the system 10 performs the following optional steps in some order:

In one optional step, select a point. This can be a wall/floor intersection point pair selected at random or a candidate point pair;

In a second optional step, use the evaluation function to score the candidate point pair.

In a third optional step, refine the candidate point pair using, for example, the following sub-process:
1. Make all the possible smallest possible changes (for example 1 pixel movement of one point) to the candidate point to generate several additional candidate points, for example 8;
2. Evaluate these candidates and select the one that scores highest on the evaluation function. The candidate point with the highest score and the original point are used in the next step.”;
3. If the original was the best go onto Step 4 using the original otherwise go back to sub-step 1 using the point with the highest score as the new original/candidate point.

In a fourth optional step, record and optionally score the refined candidate point pair, for example in the storage system.

In a fifth optional step, return to the first optional step above with a new candidate point or a new random point until n iterations has been reached.

In a sixth optional step, select a refined point pair across all iterations.

In a seventh optional step, use the refined point pair to split the image into the relevant ground area, the relevant wall area and areas that are not relevant to the current wall/floor intersection. For example, in FIG. 4C, the wall that is not used for filling in the filled in wall is one such non-relevant area. Here, the non-relevant area is determined by first establishing whether or not the version where the line specified by the refined point pair (the wall/floor dividing line) extends to the edges is being used or not. If this version is being used which is most appropriate to situations where there is only one wall in the image the entire image is used and the line extended to the edges divides the image into wall and ground area. In cases where there is more than one wall, the version which does not extend the line to the edges of the image may be used. In this version of the algorithm two lines perpendicular to the wall/floor dividing line are found. These lines both have the same slope and one intersects the first point in the refined point pair and the second one intersects the second point in the refined point pair. These lines as well as the wall dividing line are used to segment the image into the regions of the floor, the relevant wall and potentially non-relevant regions.

In an eighth optional step, project the gravity vector into the 2D image space. For example, if the picture was taken in a normal level camera and the x represents the left to right direction in the image and y represents the bottom to top direction in the image the gravity vector would project to (0,−1) in the (x,y) image coordinate system.

In a ninth optional step, convert the coordinate of each image sample or pixel into an estimate of its depth with respect to gravity using the dot product. This is achieved by taking the dot product of the image coordinate and the gravity vector or Depth with respect to gravity, D, where D is the Image Coordinate DOT Projected Gravity Vector.

In a tenth optional step, compute the closest point for each image sample on the wall/floor dividing line specified by the refined point pair. Here, the closest point is computed using any efficient well-established method to compute the closest point on a line to a given point. One example is finding a line perpendicular to the wall/floor dividing line that intersects the image point being examined and then finding the intersection of the wall/floor dividing line and this new perpendicular line. For image samples that lie exactly on the wall/floor dividing line they can be assumed to be on either the wall or the floor or excluded.

In an eleventh optional step, compare the depth with respect to gravity of each image sample coordinate to the depth with respect to gravity of the point on the wall dividing line that is closest to the image coordinate as calculated in the tenth optional step above. Here, if the depth with respect to gravity of the image sample coordinate is greater than that of the nearest point on the wall/floor dividing line than the image sample is on the floor. If it is less than that of the nearest point on the wall/floor dividing line then the image sample is on the wall/plane. For example for an image point, IP, (10,200) and the nearest point on the wall/floor dividing line, NP, (10,100) and the gravity vector (0,−1) the depth of IP, DIP, would be −200 and the depth of NP, DNP would be −100. Because −200 is less than −100 IP is located on the wall/plane.

In a twelfth optional step, if the version where the wall/floor dividing line extends to the edges of the image is used the set of samples belonging to the wall region and the set of samples belonging to the floor region are used as the final wall/floor areas. If the other version is used the lines perpendicular to the wall/floor dividing line (the relevant area dividing lines) calculated in the seventh optional step described above are used to determine if a sample is in a relevant area or not. Each image sample whose image coordinates are in-between or on the relevant area dividing lines is in the relevant area. Any image sample that is not between the relevant area dividing lines is not in the relevant area.

It is understood that in one example, the final result is either 2 or 3 image regions, the relevant area on the wall/plane, the relevant area on the floor/ground plane and the non-relevant areas, which may not be contiguous. The floor/ground plane areas and the wall/plane areas are contiguous.

In some embodiments, rather than using the per-sample approach described in steps 7-12, a more efficient approach may be used where the image is split into up to 6 regions using the wall/floor dividing lines and the relevant area dividing lines. In FIG. 4D, the relationship between the wall/floor dividing line Y, the relevant area lines Z₁, Z₂ and these regions P, Q, R, S, T, U is demonstrated. It is understood that 1 line and 2 other lines parallel to the first line that are not the same line divide any space into 6 regions.

Here, each region shares the property of whether it is a non-relevant area, the floor/ground plane area or the wall/plane area. In some embodiments this property is determined for the whole region by sampling a single point N in the region and determining which area it is in. In FIG. 4D, regions P, R, S, and U are all in the non-relevant area, region Q is on the wall/plane and region T is on the floor/ground plane. The samples in these regions can then be determined by using common more efficient methods such as scan-line algorithms or using polygonal projection in a GPU graphics pipeline.

In these implementations, image segmentation techniques known in the art—such as conditional random fields—can be utilized by the system to produce and refine the segmentation between, for example, an object, the foreground, the ground and/or a wall. In these implementations, the segmentation can be approved or accepted, either by the user or by attaining a score or threshold for segmentation quality used by the system.

Returning to FIG. 4C, in these implementations, after image 88 approval the system 10 is able to digitally remove a chosen object 90 and use the projected floor 92, wall 94 areas and intersection 95 areas as sample sources to recreate the wall 92A, floor 94A and/or intersection 95A voids left by the object 90 using, for example, “content aware fill” algorithms known in the art to generate fill floor 92B, fill wall 94B and fill intersection 95B in the image 88. This approach represents a significant improvement over prior art applications of these algorithms because only the wall, and ground are used as sample sources for the appropriate areas being filled. The result is the clean removal of an object 90 in respect to the wall/floor intersection 95 in the resultant image 88A.

Additionally, continuing with FIG. 4C, in certain examples, the floor 92, wall 94, and the floor/wall areas 95 to be filled in may be resampled into a space where the floor is not affected by perspective and the wall is unaffected by perspective. In this case the floor plane 92 and wall plane 94 and missing elements 92A, 94A, 95A will be re-projected using standard perspective projection math into an orthographic perspective. The entirety of foreground objects can be eliminated in this resampled space and new floor and wall will be generated for all samples. This space will then be resampled to create new perspective correct floor and wall samples where the removed object used to be. This has two important side effects. One is improved object removal that correctly matches the wall/floor. Another is that once this process is complete foreground objects can be removed and moved at will like cardboard cutouts and the wall/floor behind them will remain consistent and can be used to generate a layered 3D scene.

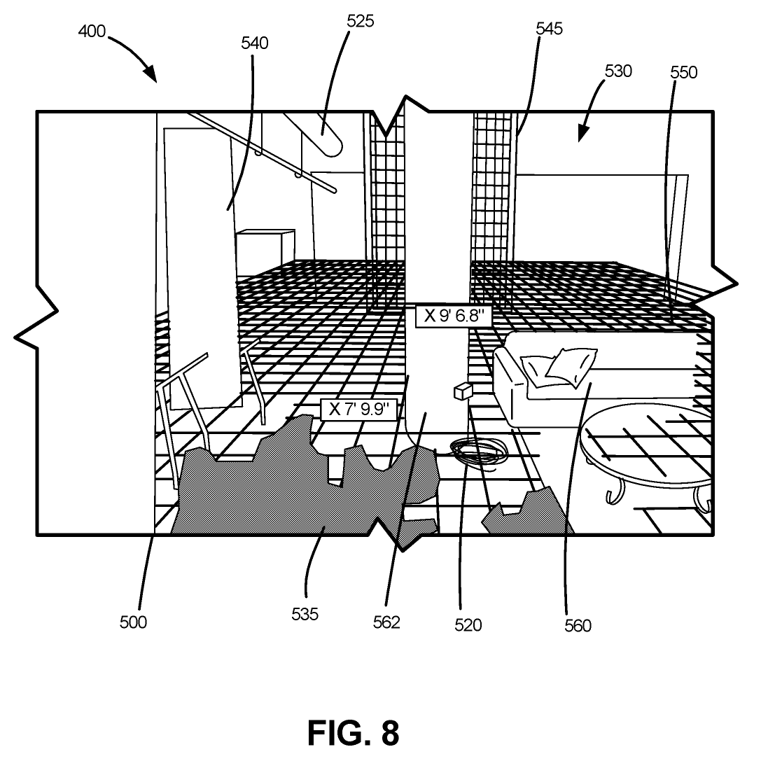

Continuing with FIGS. 4A-C, according to at least one embodiment, the device can project the found plane C into the visual information's native coordinate system 380A, 380B, which allows a user to perform measurement and object placement actions on these planes. This is depicted in FIG. 8, which depicts an overlay of the extended ground plane 550 on the three-dimensional depth-integrated color image 400 within the entire image 500. Because the rendering is highly accurate, the measurement and object placement take place at the full resolution of the color view as long as the object is within a found or defined plane. In these embodiments, the vision system 10 allows objects rendered in the three-dimensional depth-integrated color image 400 of the optical device (box 12 in FIG. 1) to be placed or analyzed precisely. For example, with user input defining a juncture or intersection between the distal ground plane C and a perpendicular structure such as a wall (for example as designated in FIG. 4A at point E or in FIG. 4B at K), the vision system 10 can compute the dimensions of D, C or walls adjacent to C. The system 10 can also make use of the ceiling parallel to C, along with the dimensions of objects contained within the space from A to D, by projection into the visual information's native coordinate system 380A, 380B. Other embodiments are also possible.

To further demonstrate the ground plane extension, FIGS. 5-7 show exemplary embodiments of a fixed image 500 created by the vision system, which in FIG. 5 represents the visual information's native coordinate system (also shown at 380A, 380B in FIG. 4B). In FIG. 5, a known object 502 is depicted, having a first end 504 and second end 506. In FIG. 6, depth data from the depth camera is depicted as a depth overlay 510, and the remaining image 512 is comprised of visual information from the color camera (the visual information's native coordinate system 380A, 380B in FIG. 4B). As is apparent from FIG. 6, the depth overlay 510 is limited to the proximal field of view, and is “patchy,” meaning not consistent within that area.

In these embodiments, the vision system 10 is able to measure the horizontal distance between the first end 504 and second end 506 of the known object 502. As was discussed in relation to FIGS. 4A-4B, the measurement is performed by identifying junctions in the planes and extrapolating the coordinate information inside the frustum 320 out into the image 500. It would be difficult or impossible to make such measurements using traditional approaches. However, the vision system 10 is able to find the proximal ground plane 520 with a high degree of accuracy and extend it into the distal ground plane 522. The system 10 is thus able to accurately construct and map the depth information for the entire image 500. The system 10 in this implementation is thereby able to create a digital reconstruction of the entire image 500 field of view (here, a room), comprising both depth and visual information, as shown in FIG. 4B at 400.

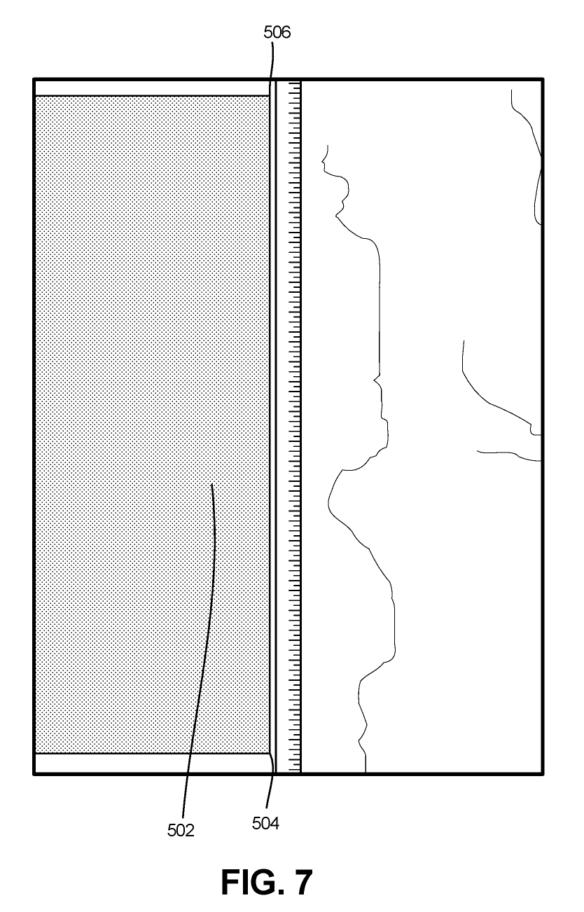

For example, as shown in FIGS. 5-6, the vision system 10 can precisely identify the distance from the first end 504 to the second end 506 of the known object 502, in this embodiment approximately 1.618351 meters. The actual distance as measured by a tape measure, shown in FIG. 7, is 64″ or 1.6256 meters. The system 10 is thus able to measure the object outside of the range of the depth camera to within 7 millimeters of the actual distance. Routine optimization of the intrinsic camera properties can both improve the accuracy of the vision system and make the vision system reproducible in a wide variety of settings including on walls and ceilings where depth data does not exist but can be seen in the visual information's native coordinate system 380A, 380B.

FIG. 8 depicts an overlay of the extended ground plane 550 on the three-dimensional depth-integrated color image 400 within the entire image 500. Exemplary embodiments can utilize a variety of planes, such as the ceiling 525 or the floor (the proximal ground plane 520) or a combination of ceiling 525 and floor 520 as well as corners 535 and edges 540 to generate the three-dimensional depth-integrated color image 400. Further, the system is able to identify end planes 545, such as a far wall, through the combination of automatic and manual data collection, as discussed in relation to FIGS. 4A-B. This combination of data collection methods allows users to choose the best approach for any given space with a specific layout and furnishings, and the data is not jeopardized by the user standing on an object or on a recessed part of the floor.

In another embodiment, the vision system 10 can be used to employ the ability to measure more accurately on an extracted ground plane 550 to create a floor plan 530 for a room based on wall distances, such as that to the end plane 545. In certain implementations, this can be augmented by taking a depth image of corners of the room, finding the planes associated with corners 535 and edges 540 and assigning them in the floor plan 530. Some areas may be occupied with objects 560 including furniture. By determining the floor plan 530, certain implementations are able to remove objects 560 automatically, for example furniture rendered in the three-dimensional depth-integrated color image 400. Certain of these implementations can either fill in the three-dimensional depth-integrated color image 400 where the object 560 was with a solid image or standard texture 562. Other embodiments can map the missing areas of the floor along with the known areas of the floor and apply “content aware fill” filters to fill in the ground plane with visually plausible vision and texture.

In another embodiment, the vision system can use data of extracted planes (such as that shown in FIG. 8 at 545) to assess defects in walls, floors, ceilings, or other structures. This allows the device to calculate the size and shape of any defect, thus enabling other approaches to repairing the defect (e.g. 3D printing a mold and filling it as a way to repair a defect in a ceiling when it would be otherwise impossible to pour concrete).

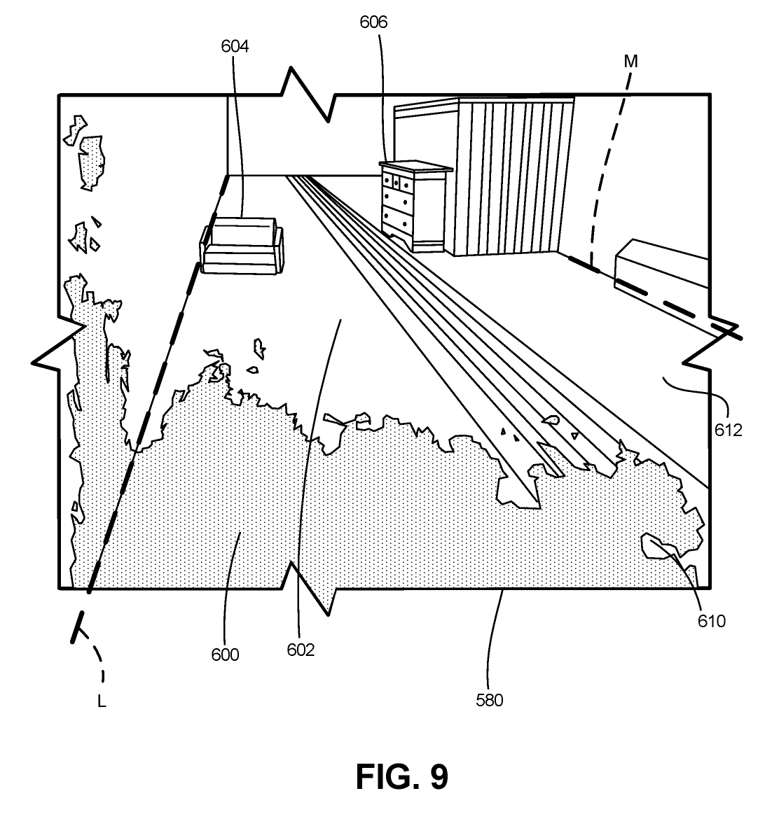

Plane reconstruction allows various implementations to swap out existing furniture or other objects for new scaled-virtual furniture or other objects for applications such as interior decorating. In FIG. 9, depth data from the depth camera is depicted as a depth overlay 600, and the remaining image 602 is comprised of visual information from the color camera. Two three-dimensional virtual objects (here, for purposes of example a chair 604 and a dresser 606) have been placed in the field of view 580 to showing the proper alignment of the objects with the ground plane (represented by reference lines L and M). The system 10 makes the accurate scaling and placement of these virtual objects (the chair 604 and dresser 606) possible through the extrapolation of precise depth information. In part, this analysis is done through cloud computation on data uploaded by a computing device attached to a depth camera and vision camera.

As is shown in FIG. 9, both the chair 604 and dresser 606 are beyond the point where depth data can be directly derived, as is represented by the depth overlay 600. As noted above, active IR cameras (both structured light and ToF) perform poorly or not at all in sunlight conditions due to the noise from the IR emitted by the sun. However, by extrapolating from the ground plane (as represented by reference letters L and M) found by the depth camera (140 in FIG. 2, above) shaded area 610 in exemplary embodiments to the sunlit area 612 on the ground plane in the vision camera (160 in FIG. 2); the vision system 10 is able to overcome these limitations. In so doing, the vision system 10 improves the technology greatly more useful for applications such as decorating, design, architecture, and construction as well as any outdoor use of the technology.

Accordingly, FIG. 9 depicts the ability to address bright sunlight 612 where the natural IR from the sun interferes with the active IR from the devices. In these implementations, the vision system 10 can utilize naturally shaded areas 610 (where the ground plane L is either detected automatically or defined by a user) to extrapolate areas of the ground plane M where sunlight impedes active mapping. In instances where no natural shade exists, these implementations can add shade to areas of the ground plane to actively shade sections of the ground plane in the rendered field of view and use that shade to extrapolate or define the ground plane L, M. As would be apparent to one of skill in the art, shade allows the depth camera (140 in FIG. 2, above) to function so you can extrapolate the ground plane in the vision camera (160 in FIG. 2).

Together the combined approaches in the various embodiments and implementations allow the system to perform several useful tasks not covered in the prior art. These include: making measurements or placing objects on the ground plane in a single image at a distance greater than 8 meters (or making a single measurement that exceeds 8 meters or placing a single object larger than 8 meters in one or more dimensions), making measurements or placing objects on walls or ceilings in a single image at a distance greater than 8 meters (or making a single measurement or placing a single object that exceeds 8 meters), and determining room layouts, amongst others.

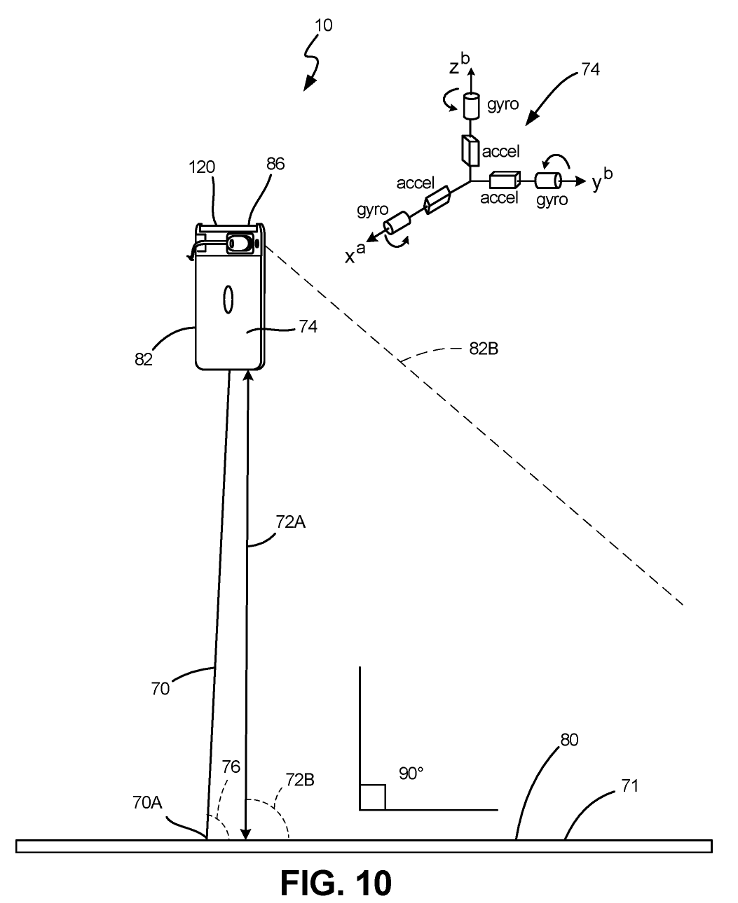

As is shown in FIG. 10, in certain embodiments the optical device 120 does not require the use of a depth camera to function. Instead, these embodiments rely on a combination of a monopod 70, tripod or other fixed frame of reference between the optical device 120 and the ground 71. In these embodiments, the system 10 determines the direction of gravity 72A by way of an internal measurement system 74. The internal measurement system 74 may be an inertial measurement unit (“IMU”), gyroscope, accelerometer, and/or magnetometer. From the direction of the gravity vector 72A, the system 10 is also able to determine the reference angle of inclination 72B of the ground 71 in the area to account for any slope in the ground relative to gravity 72A. In certain embodiments, the reference angle 72B is obtained by laying the camera or mobile device flat on the ground 71. This is necessary because the ground 71 may well not be perfectly flat relative to gravity 72A, and thus the ground plane must be correspondingly corrected to account for these differences. In some cases the assumption that the ground is flat may be adequate for the intended purpose.

In further embodiments, estimation of the distance to the ground plane can be performed using a dual camera system. Various implementations of the duel camera system can optionally natively support depth map creation. In these embodiments, an estimate of a probable range of distances from the dual camera system to the ground can be produced by using feature matching between both cameras. As used herein, “feature matching” means using features such as SIFT, SURF, ORB, BRISK, AKAZE and the like for semi-global block matching, or other known methods to produce a disparity map, which can be sparse or dense. In these implementations, the disparity map can be filtered to limit the scope to depths that are plausible for ground-height distances for a handheld camera and the remaining disparity values as well as the values that were filtered out are used to create an estimate of the distance to the ground plane.

Continuing with FIG. 10, the system 10 is further able to establish the monopod angle 76 based on the reference angle 72B and known monopod 70 length. The combination of the monopod angle 76, reference angle 72B, and the distance 78 between a fixed point of reference on the ground 70A (given by the monopod 70 length), and the optical characteristics of the optical device 120 allow the system 10 to project a dimensionally accurate ground plane 80 into the picture 82. By way of further example, the angle of the monopod 70 is unlikely to be exactly a right angle in all directions. Accordingly, the monopod distance 70 between the ground 71 and optical device 120 serves as a hypotenuse, with the gravity vector 72A serving as another leg of the triangle. These known lengths and angles can thus serve as trigonometric constants used to calculate the ground plane by way of the intrinsic camera properties described above in relation to FIG. 3. In FIG. 10, knowledge of the frame of reference can be combined with visual information such as features, texture, output of structure from the visual camera is used together to provide the most accurate knowledge of the ground plane 80 and of a depth map 82B of objects resting on the ground plane or elsewhere in the picture 82.

The implementations such as that of FIG. 10 can refine the fit for the ground plane 80 by gravity vector 72A alignment or other internal measurement system 74 information. An alternative approach to refining ground plane finding capability on mobile devices that contain both a front-facing and rear-facing camera is to use the front-facing camera and established methods for finding faces along with a user's height to determine the height and angle of the device from the floor. Certain embodiments of the vision system 10 can further refine the estimate of the ground plane 80 by using data from the internal measurement system 74. These additional embodiments would instruct the user to place his or her phone on the floor. These embodiments would contain certain implementations that are configured to a noise producing device 86. The noise producing device in these implementations would produce a beep that would alert the user that the calibration/data is acquired. At that point, the user would take a photo of objects rendered in the field of view as previously described.

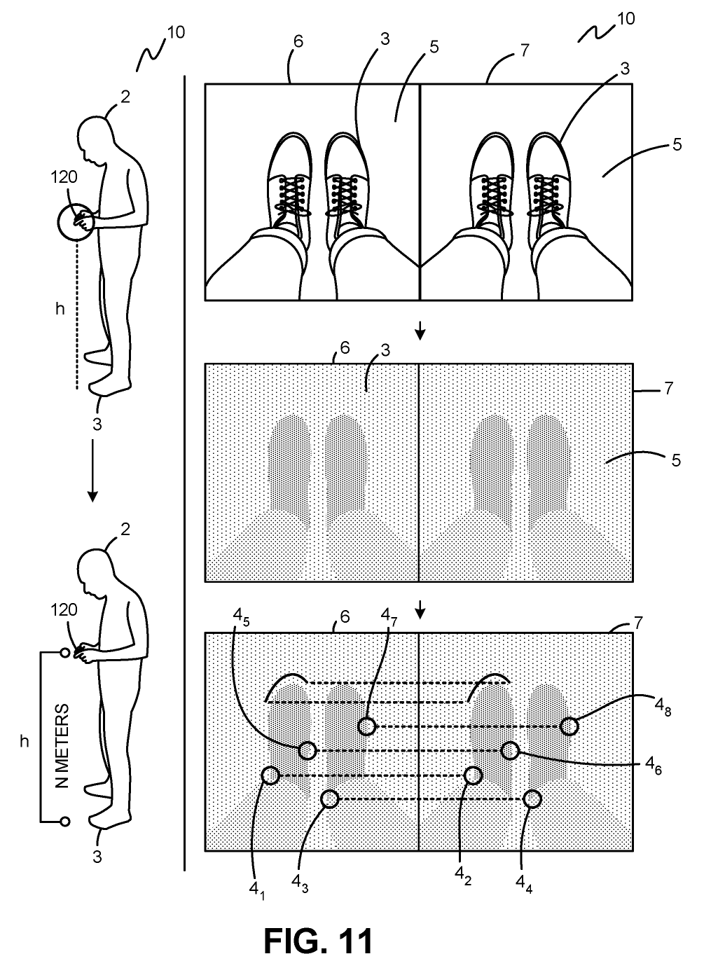

In certain implementations, and as shown in FIG. 11, there may not be enough visual structure on the ground to create a quality ground-distance estimate. In these situations, the system 10 may ask the user 2 to point the camera 120 at the users feet/shoes 3 from the camera height h and position being used. In these implementations, the paired intersection(s) 4₁, 4₂, 4₃, 4₄, 4₅, 4₆, 4₇, 4₈ of the users shoes 3 with the ground 5 can provide sufficient ground-distance information when paired with a dual camera (represented in FIG. 11 with bilateral vision panes 6, 7) using even a minimal baseline, such as that available on current mobile devices like the iPhone® 7+. In this case, some embodiments may use standard stereo matching techniques discussed above. Other embodiments may use custom shoe detection or segmentation using convolutional neural nets and/or conditional random fields combined with semi-global matching using only the image regions containing the users shoes or other critical objects and constrained to disparity values that are possible for a handheld picture of the ground.

FIG. 11 demonstrates how this segmentation could be used. In this implementation, the floor/ground plane 5, the shoe area (defined by the intersections 4₁, 4₂, 4₃, 4₄, 4₅, 4₆, 4₇, 4₈), and the non-shoe or ground area (shown at 5) are segmented into separate regions of the image as represented by the image shading in FIG. 11. The shoe/ground intersections may not be reliably matched using standard features but the knowledge of these regions and the narrow baseline of the camera allows for semi global matching of just the curve between the front of the shoe and the ground.

This semi-global matching could take the knowledge that the ground is oriented perpendicular to gravity into account such that the distance to the ground can be represented as a global property of the alignment between the two images and the intersection between the shoe and floor/ground plane regions. This global property can be used to create a 2D matrix where each floor/shoe intersect point in the left image is represented by one row and each floor/shoe intersect point in the right image is represented by one column. The elements of the matrix represent the distance to the floor assuming that the points in the column associated with the element and the row associated with the element are the same point. This distance is calculated using the gravity vector, the assumption that the floor/ground plane is perpendicular to the gravity vector, the intrinsics and extrinsics of the cameras and standard stereo projection math. This matrix is used to determine the most probable distance to the floor given the sets of points in both images by finding the distance that best explains the set of correspondences given that each ground plane intersection point in the left image should match only one ground plane intersection point in the right image.

In some embodiments the ground plane/shoe intersection sample points may be sampled in such a way that they are both spread out enough to make this property true and likely to line up (by using the camera extrinsics and aligning the sample points in the direction of the stereo baseline). Additionally the stereo baseline direction and alignment with the images may be used to exclude implausible matches between ground/shoe intersection points. In other embodiments it may be necessary to adjust the set of sample points so that this is true. In other embodiments the true orientation of the floor/ground plane may be used as another parameter to be recovered. This global estimate of the distance from the camera to the ground is then used for calculations for distances along the ground plane, visualization of objects etc in images taken from other orientations. (The system might have the user take the picture they want to use and then point the camera at their shoe from the same location and then use the ground plane distance estimate from the shoe picture in the original picture.)

In alternate embodiments this process may be performed using only a single camera and a several images combined with sensor odometry of the IMU while those images are taken. For instance the phone could be rotated or moved left and right and the ground plane distance could be calculated that maximally explains the IMU odometry, the distance to the ground plane, the camera intrinsics and the IMU orientation in each image.

Additional embodiments use an optical device (box 12 in FIG. 1) which is a stereo camera (such as an RGB, infrared, black and white or other camera) in conjunction or without active IR or other structured light to allow for some level of depth sensing capability outside the limitations of active IR or visible structured light. In these embodiments, found planes from either stereo vision-based depth samples or active IR/structured light depth samples are used to extrapolate the planes into relatively featureless or textureless areas that the stereo camera approaches traditionally have struggled to model. These embodiments can increase the robustness of estimations made on these systems and allow for improved object placement and measurement.

Further embodiments can apportion error in the x-, y-, and z-dimensions. Typically, distal points have greater potential error in all dimensions. The error associated with different spatial dimensions may not accumulate in the same fashion as a function of distance. For example, certain implementations are configured to a structured light sensor within the optical device (box 12 in FIG. 1). These implementations on a Structure Sensor® are configured to have a depth error curve as a function of distance. The depth error recorded by these implementations is complex, and measurements at the perimeter of an image may be more accurate than in the center. In other implementations with different sensor configurations the opposite may be true based on data provided by the manufacturer. Certain implementations on hardware with different or unknown error characteristics may also gather or estimate the error using successive depth readings and calibrations. Yet another embodiment can record an error that varies from point-to-point and instance-to-instance in objects rendered in the field of view to refine the fit of the ground plane C, as is shown in FIGS. 4A-C.

Certain implementations may also be configured to a processing unit that contains a plane finder. Certain implementations with processing units that contain plane finders also contain error finders. In these implementations, the plane finder takes each point returned by the depth camera and evaluates where in real physical space that point is likely to be using a probabilistic model with inputs from the accelerometer, other adjacent points, and other data of the error from heuristics, spec sheets, calibrations and other sources.

Many actual ground planes such as floors contain macroscopic deviations from a perfect plane. Because of this, certain implementations are configured to processing units that are programmed to be careful of not over-fitting to points where the processing unit calculates the measurement error as small by discarding points that vary from an idealized ground plane. In these implementations, this discarded criteria may either be the same for all points or may vary based on the probabilistic model that the vision system creates.

In certain applications, such as integrating the built environment with software packages such as AutoCad® and SketchUp®, architects and other professionals may not wish to work with a full model of a surface containing all of its small imperfections. In these cases, the system can be configured to find and export surfaces as idealized planes. Other implementations may be configured to scan a surface that systematically varies from a plane, such as a road with a drainage gradient. In these cases, the plane finder takes each point returned by the depth camera, and with input from the user other curvilinear surfaces can be fitted. Additional exemplary embodiments of the vision system allow the user to virtually remove objects and project empty spaces based on content-aware fill approaches; to scan and determine the properties of material defects in floors, ceilings, walls and other structures to enable alternative repair approaches; and to make measurements in areas outside with bright sunlight on the ground plane where partial shade exists or can be created.

Although the disclosure has been described with reference to preferred embodiments, persons skilled in the art will recognize that changes may be made in form and detail without departing from the spirit and scope of the disclosed apparatus, systems and methods.

What is claimed is:

1. A vision system comprising:
a. a depth camera configured to render a depth sample;
b. a vision camera configured to render a visual sample;
c. a display; and
d. a processing system, wherein the processing system is configured to:
i. interlace the depth sample and the visual sample into an image for display,
ii. identify one or more planes within the image,
iii. create a depth map on the image, and
iii. extend at least one identified plane in the image for display.

2. The vision system of claim 1, wherein the processing system is configured to utilize a frustum to extend the plane.

3. The vision system of claim 1, further comprising a storage system.

4. The vision system of claim 1, further comprising an application configured to display the image.

5. The vision system of claim 4, wherein the application is configured to identify at least one intersection in the frustum.

6. The vision system of claim 4, wherein the application is configured to selectively remove objects from the image.

7. The vision system of claim 6, wherein the application is configured to apply content fill to replace the removed object.

8. The vision system of claim 1, wherein the image is selected from a group consisting of a digital image, an augmented reality image and a virtual reality image.

9. The vision system of claim 1, wherein the depth camera comprises intrinsic depth camera properties and extrinsic intrinsic depth camera properties, and the vision camera comprises intrinsic vision camera properties and extrinsic intrinsic vision camera properties.

10. The vision system of claim 9, wherein the processing system is configured to utilize intrinsic and extrinsic camera properties to extend the plane.

11. A vision system for rendering a static image containing depth information, comprising:
a. a depth camera configured to render a depth sample;
b. a vision camera configured to render a visual sample;
c. a display;
d. a storage system; and
e. a processing system, wherein the processing system is configured to:
i. interlace the depth and visual samples into a display image,
ii. identify one or more planes within the display image, and
iii. create a depth map on the display image containing depth information that has been extrapolated out beyond the range of the depth camera.

12. The vision system of claim 11, wherein the processing system is configured to project a found plane.

13. The vision system of claim 11, wherein the processing system is configured to detect intersections in the display image.

14. The vision system of claim 13, wherein intersections are detected by user input.

15. The vision system of claim 13, wherein the intersections are detected automatically.

16. The vision system of claim 13, wherein the processing system is configured to identify point pairs.

17. A vision system for applying depth information to a display image, comprising:
a. a optical device configured to generate at least a depth sample and a visual sample; and
b. a processing system, wherein the processing system is configured to:
i. interlace the depth and visual samples into the display image,
ii. identify one or more planes within the display image, and
iii. extrapolate depth information beyond the range of the depth camera for use in the display image.

18. The vision system of claim 17, wherein the processing system is configured to place new objects within the display image.

19. The vision system of claim 18, wherein the processing system is configured to allow the movement of the new objects within the display image.

20. The vision system of claim 19, wherein the processing system is configured to scale the new objects based on the extrapolated depth information.
